(19) United States
(12) Patent Application Publication
(10) Pub. No.: US 2019/0097194 A1
(43) Pub. Date: Mar. 28, 2019

(54) BATTERY SYSTEM

(71) Applicant: Mahle International GmbH, Stuttgart (DE)

(72) Inventors: Stefan Hirsch, Stuttgart (DE); Caroline Janzen, Stuttgart (DE); Michael Moser, Ellwangen (DE); Heiko Neff, Auenwald (DE)

(21) Appl. No.: 16/139,030

(22) Filed: Sep. 22, 2018

(30) Foreign Application Priority Data
Sep. 22, 2017 (DE) 102017216841.2

(51) Int. Cl. H01M 2/10; H01M 10/613; H01M 10/625; H01M 10/6568; H01M 2/30; B60K 6/28; B60L 11/18

(52) U.S. Cl. CPC H01M 2/1083; H01M 10/613; H01M 10/625; H01M 10/6568; H01M 2/305; B60Y 2400/112; B60L 11/1879; B60L 11/1874; B60Y 2200/91; B60Y 2200/92; B60K 6/28

(57) ABSTRACT

A battery system for a vehicle may include a battery system housing, at least one module carrier, at least one battery cell module and at least one pivotable locking lever. The at least one battery cell module may include a fluidic module cooling circuit, a fluidic first module interface, and an electrical second module interface. A fluidic first carrier interface and an electrical second carrier interface may be arranged on the at least one module carrier. The at least one battery cell module may be adjustable relative to the at least one module carrier into an end position via pivoting the at least one locking lever. In the end position, the first module interface may be coupled to the first carrier interface and the second module interface may be coupled to the second carrier interface.

### CROSS-REFERENCE TO RELATED APPLICATIONS

This application claims priority to German Patent Application No. DE 10 2017 216 841.2, filed on Sep. 22, 2107, the contents of which are hereby incorporated by reference in its entirety.

### TECHNICAL FIELD

The present invention relates to a battery system. In addition, the invention relates to a vehicle in particular a hybrid or electric vehicle having such a battery system.

### BACKGROUND

Battery systems in hybrid or electric vehicles are usually constructed of individual battery modules or battery cell modules. The individual battery modules can be employed in a module carrier with a battery system housing and preferentially mechanically connected to the battery system housing using multiple screw connections. Following this, the individual battery modules can be connected to the module carrier in separate assembly steps via a fluidic and electrical connection, wherein the fluidic connection is provided for cooling and the electrical connection for electrically contacting the individual battery modules.

Here it is disadvantageous in particular that the assembly is relatively expensive and involves major time expenditure. It is disadvantageous, furthermore, that the screw connections, the interconnections of the individual battery modules as well as the fluidic and electrical connection of the individual battery modules to the module carrier are often defective because of the complicated assembly. Constructions, which include a multiplicity of different operations, which additionally have to be executed sequentially one after the other and have to be mostly performed manually are highly susceptible to error in this case. The electrical connection of the individual battery modules to the module carrier is dangerous for the worker because of the danger of electrocution. A defective fluidic connection of the individual battery modules to the module carrier can result in a leakage and because of this in a battery system short circuit.

### SUMMARY

The present invention therefore deals with the problem of stating an improved or at least an alternative embodiment for a battery system, which in particular overcomes the above mentioned disadvantages.

According to the invention, this problem is solved through the subject matter of the independent claim(s). Advantageous embodiments are subject of the dependent claim(s).

The present invention is based on the general idea of providing a battery system with a battery system housing, at least one module carrier, at least one battery cell module and at least one locking lever, in the case of which the respective battery cell module contains a fluidic module cooling circuit and comprises a fluidic first module interface, which for fluidically connecting the module cooling circuit can be coupled to a fluidic first carrier interface formed on the module carrier. The respective battery cell module comprises an electrical second module interface for the electrical contacting, which can be coupled to an electrical second interface formed on the module carrier and serves for electrically connecting the individual battery module to the module carrier. The locking lever is pivotably mounted on the module carrier about a pivot axis between an open position and a locking position. In the open position of the locking lever, the respective battery cell module is insertable into the module carrier and removable there from, and in the locking position of the locking lever, the respective battery cell module is fixed on the module carrier. The respective battery cell module is insertable into the module carrier in a first assembly direction running transversely to the pivot axis. When inserting the battery cell module, the respective battery cell module assumes an intermediate position relative to the module carrier, in which the first module interface and the second module interface are orientated in a second assembly direction extending transversely to the first assembly direction and transversely to the pivot axis aligned with the carrier interface and with the second carrier interface and arranged spaced therefrom. In this intermediate position, the respective battery cell module is in engagement with the respective locking lever adjusted into its open position. By pivoting the locking lever, the respective battery cell module is adjusted in the second assembly direction relative to the module carrier into an end position. In this end position, the first module interface is coupled to the first carrier interface and the second module interface is coupled to the second carrier interface, as a result of which a fluidic and electrical connection of the respective battery cell module to the module carrier is ensured. The use of a battery system according to the invention is advantageous since for the assembly of the individual battery modules only a single operation instead of multiple operations is necessary, for which ideally no further operating facilities are necessary. This does not only ensure a quick and cost-effective assembly but also a quicker and more cost-effective exchange of defective battery cell modules in the event of maintenance. It is advantageous, furthermore, that the individual battery cell modules do not make possible any direct access to live parts, as a result of which a hazard to assembly and/or service personnel is reduced.

A possible embodiment proposes that the battery cell module comprises at least one pin projecting parallel to the pivot axis. The pin is arranged on the end of the battery cell module facing the module carrier.

Practically it can be provided, furthermore, that the locking lever comprises at least one pin receptacle. The pin receptacle is designed in such a manner that the pin can dip into the pin receptacle. When the locking lever is located in its open position, the respective battery cell module can be inserted in the module carrier with the pin in the first assembly direction. The respective battery cell module is in engagement in the intermediate position with the respective locking lever adjusted into its open position, wherein the pin of the battery cell module has dipped into the pin receptacle of the locking lever. When the locking lever comprises at least one pin receptacle, into which the pin of the battery cell module can dip, this is advantageous since by way of this it is ensured that the battery cell module is securely mounted in the module carrier against lateral slipping by the locking lever.

In a further configuration of the invention it can be provided that the locking lever comprises a slotted link which joins the pin receptacle. During the pivoting of the locking lever the slotted link guides the pin away from the pin receptacle of the locking lever. This is practical since by way of this it is ensured that by guiding the pin away from the pin receptacle the battery cell module, on which the pin is formed, is guided in the direction of the first and second carrier interface formed on the module carrier. The first fluidic module interface or the second electrical module interface of the battery cell module is/are correspondingly guided in the direction of the first and second carrier interface. When the pin, at the end of the pivot movement of the locking lever, is located at the end of the slotted link facing away from the pin receptacle, the first fluidic module interface is in contact with the first carrier interface of the module carrier and the second electrical module interface is in contact with the second carrier interface of the module carrier. In this case, the battery cell module is electrically and fluidically coupled to the module carrier.

A further advantageous embodiment proposes that the slotted link defines a curved track having a radius which decreases from the front end of the slotted link on the pin receptacle to the rear end of the slotted link to the pivot axis. It is advantageous that the slotted link defines a curved track since a curved track guides the pin with a lower resistance from the front end to the rear end of the slotted link than other geometries. By way of this it is ensured that the pin can be guided with as low as possible a force expenditure from the front end of the slotted link to the rear end of the slotted link. Because of this it is likewise ensured that the battery cell module can be moved with as low as possible a force expenditure in the second movement direction in the direction of the module carrier. The slotted link formed as a curved track and/or the pin formed on the battery cell module, furthermore, can be formed from a material having as low as possible a friction resistance or be coated with a material having as low as possible a friction resistance.

Preferentially it can be provided, furthermore, that the respective pin in the locking position of the locking lever is located parallel to the second assembly direction and aligned with the pivot axis.

In a further configuration of the invention it can be provided, furthermore, that the locking lever comprises a grip, by way of which the locking lever can be transferred into the locking position by exerting mechanical force. When the locking lever is in its open position and a battery cell module is inserted in the module carrier in a first assembly direction, the pin of the battery cell module in the pin receptacle is located at the front end of the slotted link. When a mechanical force is exerted on the locking lever in order to pivot the same, the pin is moved away from the pin receptacle to the rear end of the slotted link facing away from the front end. When the locking lever is transferred into the locking position, the pin is located at the rear end of the slotted link. When the locking lever is in the locking position, the battery cell module can be electrically and fluidically coupled to the module carrier. In other words: by exerting mechanical force on the locking lever, the battery cell module is moved in the second assembly direction in the direction of the module carrier and is fixed on the module carrier in the locking position of the locking lever.

Practically it can be provided, furthermore, that the grip of the locking lever rests on the battery system housing parallel to the second assembly direction when the locking lever is located in the locking position. This is advantageous since by way of this it is ensured that the grip of the locking lever does not obstruct the closing of the battery system housing when the locking lever is located in the locking position and the battery system is ready for operation.

A further possible embodiment proposes that the battery system housing has a geometry which prevents a closing of the battery system housing when the locking lever is not located in the locking position. Accordingly it is possible for example that the battery system housing is designed in such a manner that the battery system housing cannot be closed when the locking lever is located in the open position. When the locking lever is located in the open position or an intermediate position between the open position and the locking position, the grip of the locking lever prevents a closing of the battery system housing which has the consequence that the battery system cannot be operated. Alternatively, a safety signal could also be provided via an electrical switch which prevents “activating” the battery system, when the locking lever is located in the open position or an intermediate position and not in the locking position. When the battery system housing has a geometry which prevents a closing of the battery system housing when the locking lever is not located in the locking position, this is advantageous since by way of this it is ensured that the battery system housing can only be closed in particular when the locking lever is located in the locking position and thus the battery cell module can be electrically and fluidically coupled to the module carrier and the battery system is accordingly ready for operation.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference characters relate to same or similar or functionally same components.

### BRIEF DESCRIPTION OF THE DRAWINGS

It shows, in each case schematically,

FIG. 1 shows a cross section of a battery system housing according to the invention with a locking lever in open position.

FIG. 2 shows a longitudinal section of a battery system according to the invention with a battery cell module and the locking lever in open position,

FIG. 3 shows a longitudinal section of the battery system according to the invention with the battery cell module and the locking lever in intermediate position,

FIG. 4 shows a longitudinal section of the battery system according to the invention with the battery cell module and the locking lever in locking position.

### DETAILED DESCRIPTION

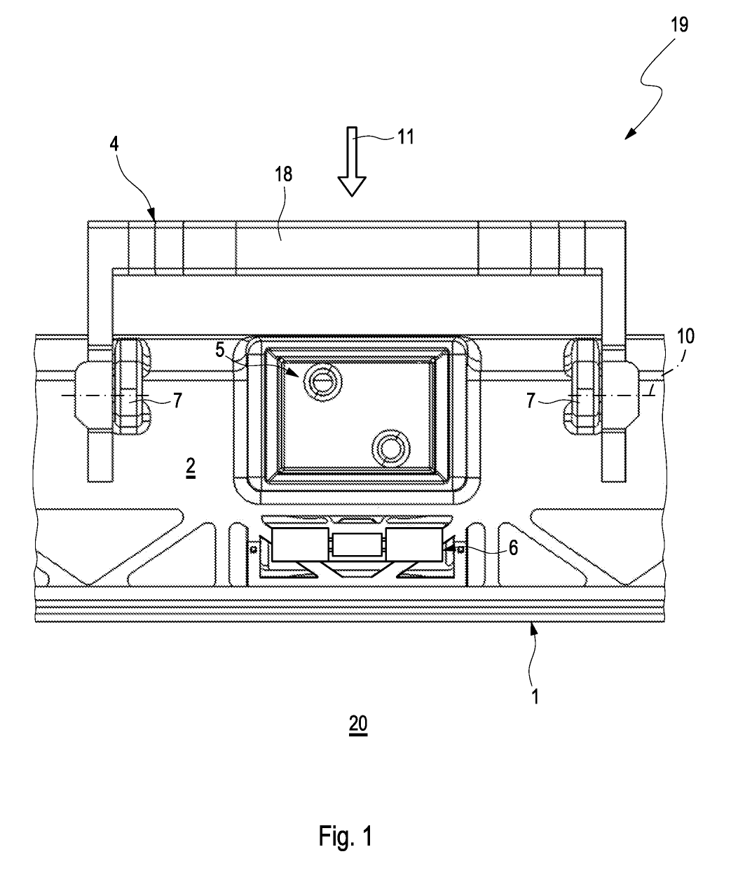

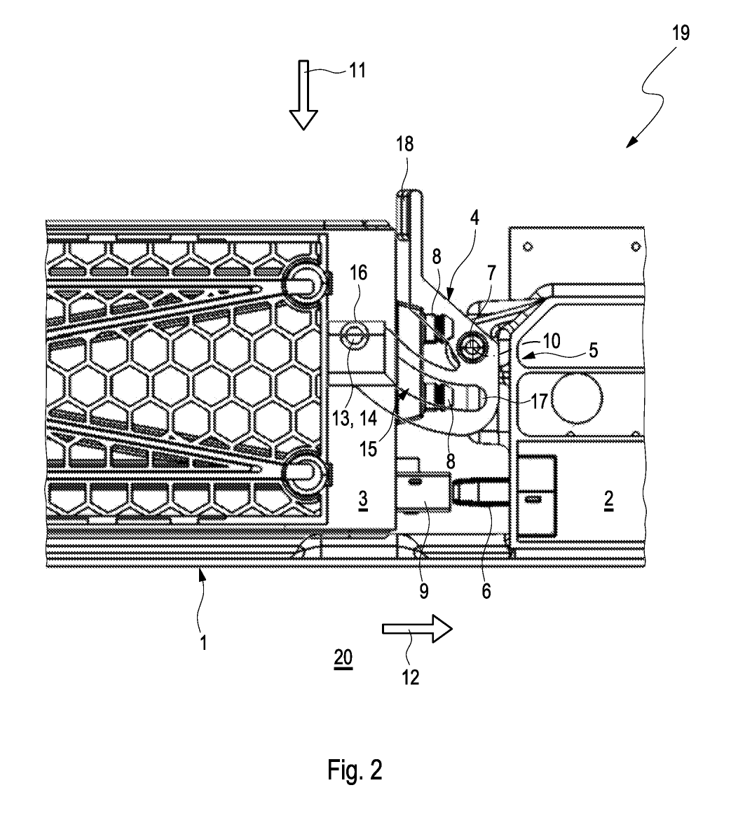

According to FIG. 1, a battery system housing 1 comprises a module carrier 2, which is designed for receiving a battery cell module 3 shown only in FIGS. 2 to 4. The module carrier 2 comprises a locking lever 4, a fluidic first carrier interface 5 and an electrical second carrier interface 6. The locking lever 4 is attached to the module carrier 2 with two attachment points 7. Here, the first carrier interface 5 and the second carrier interface 6 are arranged on the module carrier 2 between the attachment points 7.

The respective battery cell module 3 contains a fluidic module cooling circuit which is not noticeable here in more detail, which for example comprises a fluid line and a heat exchanger region incorporated therein, and comprises a fluidic first module interface 8 that is complementary to the first carrier interface 5, via which the battery cell module 3 can be coupled to the module carrier 2 and is fluidically connected to the same. The respective battery cell module 3, furthermore, comprises an electrical second module interface 9 that is complementary to the second carrier interface 6, via which the battery cell module 3 can be coupled to the module carrier 2 and can be electrically contacted.

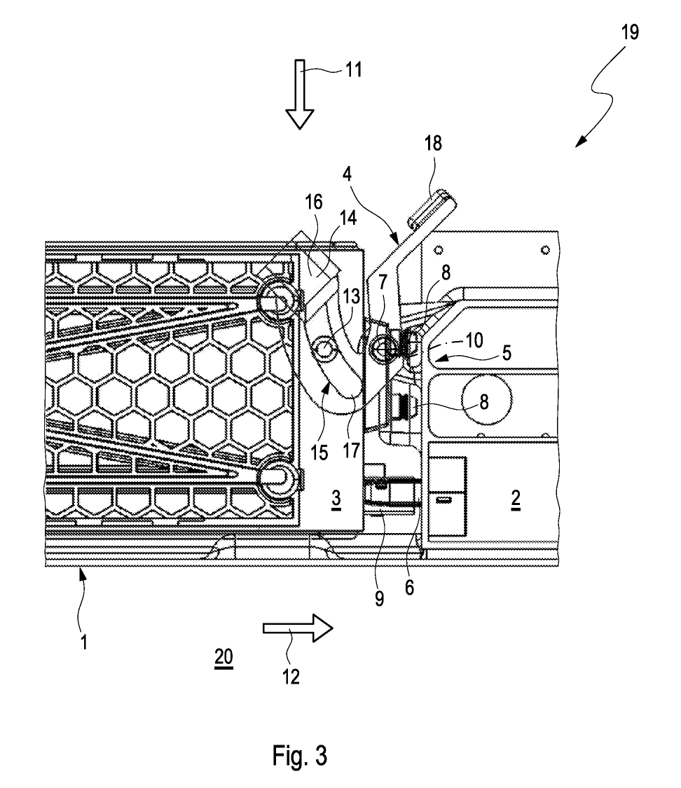

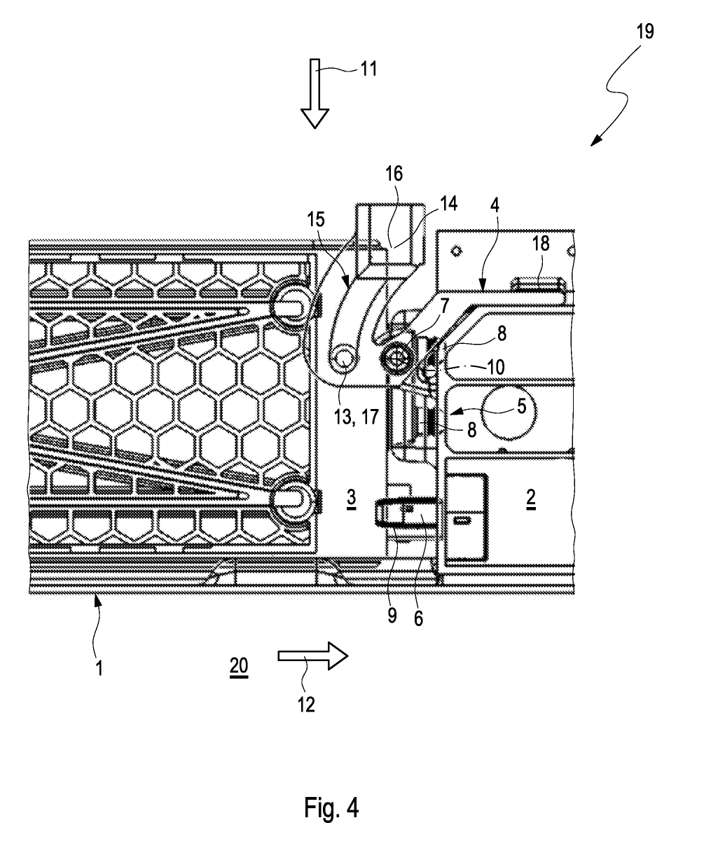

The locking lever 4 is pivotably mounted on the module carrier 2 about a pivot axis 10 at the attachment points 7. When the locking lever 4 is located in the open position (see FIGS. 1 and 2), the battery cell module 3 can be inserted in the module carrier 2 and removed from the same, when the locking lever 4 is located in the locking position (see FIG. 4), the battery cell module 3 is fixed in or on the module carrier 2. The battery cell module 3 can be inserted in the module carrier 2 in a first assembly direction 11 running transversely to a pivot axis 10, when the locking lever 4 as illustrated in FIG. 1 and FIG. 2 is located in the open position. When the battery cell module 3 is inserted in the module carrier 2, the battery cell module 3 assumes an intermediate position (see FIG. 2) relative to the module carrier 2, in which the first module interface 8 and the second module interface 9 are orientated in a second assembly direction 12 running transversely to the first assembly direction 11 and transversely to the pivot axis 10 aligned with the first carrier interface 5 and to the second interface carrier 6 and are arranged spaced therefrom. In this intermediate position, the battery cell module 3 is in engagement with the locking lever 4 adjusted into its open position. By pivoting the locking lever 4, the battery cell module 3 is adjusted in the second assembly direction 12 relative to the module carrier 2 into an end position (see FIG. 4), in which the first module interface 8 is coupled to the first carrier interface 5 and in which the second module interface 9 is coupled to the second carrier interface 6. During the pivoting of the locking lever, the locking lever 4 assumes an intermediate position (see FIG. 3) between the open position (see FIGS. 1 and 2) and the locking position (see FIG. 4).

The battery cell module 3 comprises at least one pin 13 projecting parallel to the pivot axis 10. The locking lever 4 comprises a pin receptacle 14 that is complementary to the pin 13, into which the pin 13 in the open position of the locking lever 4 dips in the first assembly direction 11 (see FIG. 2). Furthermore, the locking lever 4 comprises a slotted link 15 which follows the pin receptacle 14 and which during the pivoting of the locking lever 4 guides the pin 13 away from the pin receptacle 14. The slotted link 15 defines a curved track which has a radius that decreases from the front end 16 of the slotted link 15 on the pin receptacle 14 to the rear end 17 of the slotted link 15 to the pivot axis 10. In FIG. 2, the pin 13 is located at the front end 16 of the slotted link 15, the locking lever 4 is located in the open position. When the locking lever 4 is located in the intermediate position, the pin 13 is also located in an intermediate position between the front end 16 and the rear end 17 of the slotted link 15 (see FIG. 3). When the locking lever 4 is located in the locking position, the pin 13 is located, aligned with the pivot axis 10 and parallel to the second assembly direction 12, at the rear end 17 of the slotted link 15, wherein the battery cell module 3 is securely fixed in the module carrier 2 (see FIG. 4). The locking lever 4 has a grip 18 through which the locking lever 4 can be transferred by exerting mechanical force from the open position into the locking position (see FIGS. 2 to 4). When the locking lever is located in the locking position, the grip 18 of the locking lever 4 rests on the battery system housing 1 parallel to the second assembly direction 12 (see FIG. 4).

A battery system 19 according to the invention is arranged in a vehicle 20, in particular in a hybrid or electric vehicle and consists of any number of battery cell modules 3 and module carriers 2, wherein the any number of battery cell modules 3 and module carriers 2 are enclosed by the battery system housing 1.

1. A battery system for a vehicle, comprising:
a battery system housing, at least one module carrier, at least one battery cell module and at least one locking lever;
the at least one battery cell module including a fluidic module cooling circuit and a fluidic first module interface, which for fluidically connecting the module cooling circuit is couplable to a fluidic first carrier interface arranged on the at least one module carrier;
the at least one battery cell module further including an electrical second module interface, which for electrically connecting the at least one battery cell module is couplable to an electrical second carrier interface arranged on the at least one module carrier;
the at least one locking lever pivotably mounted on the at least one module carrier about a pivot axis, the at least one locking lever pivotable between an open position, where the at least one battery cell module is insertable in and removable from the at least one module carrier, and a locking position, where the at least one battery cell module is fixed on the at least one module carrier;
the at least one battery cell module insertable into the at least one module carrier in a first assembly direction extending transversely to the pivot axis such that the at least one battery cell module, relative to the at least one module carrier, is arrangeable in an intermediate position where the first module interface and the second module interface are orientated in a second assembly direction extending transversely to the first assembly direction and transversely to the pivot axis in alignment with the first carrier interface and in alignment with the second carrier interface and are arranged spaced apart from the first carrier interface and the second carrier interface;
the at least one battery cell module, when in the intermediate position, engaging the at least one locking lever in the open position; and
wherein via pivoting the at least one locking lever the at least one battery cell module is adjustable in the second assembly direction relative to the at least one module carrier into an end position, where the first module interface is coupled to the first carrier interface and the second module interface is coupled to the second carrier interface.

2. The battery system according to claim 1, wherein the at least one battery cell module further includes at least one pin projecting parallel to the pivot axis.

3. The battery system according to claim 2, wherein the at least one locking lever includes at least one pin receptacle, into which the at least one pin, in the open position of the at least one locking lever, dips in the first assembly direction.

4. The battery system according to claim 3, wherein the at least one locking lever further includes a slotted link which follows the at least one pin receptacle and which, during the pivoting of the at least one locking lever, guides the at least one pin away from the at least one pin receptacle.

5. The battery system according to claim 4, wherein the slotted link defines a curved track having a radius that decreases from a front end of the slotted link on the at least one pin receptacle to a rear end of the slotted link to the pivot axis.

6. The battery system according to claim 2, wherein the at least one pin, in the locking position of the at least one locking lever, is arranged parallel to the second assembly direction and aligned with the pivot axis.

7. The battery system according to claim 1, wherein the at least one locking lever includes a grip through which the at least one locking lever, through exertion of mechanical force, is pivotable can into the locking position.

8. The battery system according to claim 7, wherein the grip rests on the at least one module carrier parallel to the second assembly direction when the at least one locking lever is in the locking position.

9. The battery system according to claim 1, wherein the battery system housing has a geometry which prevents a closing of the battery system housing when the at least one locking lever is not in the locking position.

10. A vehicle, comprising a battery system including:
a battery system housing;
at least one module carrier including a fluidic first carrier interface and an electrical second carrier interface;
at least one battery cell module including:
a fluidic module cooling circuit;
a fluidic first module interface couplable to the first carrier interface for fluidically connecting the module cooling circuit to the at least one module carrier; and
an electrical second module interface couplable to the second carrier interface for electrically connecting the at least one battery cell module to the at least one module carrier;
at least one locking lever pivotably mounted on the at least one carrier module, the at least one locking lever pivotable to an open position and a locking position, the at least one battery cell module insertable and removable from the at least one module carrier when the at least one locking lever is in the open position, and the at least one battery cell module fixed to the at least one carrier module when the at least one locking lever is in the locking position;
wherein the at least one battery cell module is insertable into the at least one module carrier in a first assembly direction extending transversely to the pivot axis such that the at least one battery cell module is arrangeable, relative to the at least one module carrier, in an intermediate position where the first module interface and the second module interface are orientated in a second assembly direction extending transversely to the first assembly direction and transversely to the pivot axis, are aligned with the first carrier interface and the second carrier interface, and are arranged space apart from the first carrier interface and the second carrier interface, the at least one battery cell module engaging the at least one locking lever when the at least one battery cell is in the intermediate position and the at least one locking lever is in the open position; and
wherein the at least one battery cell module is adjustable relative to the at least one module carrier in the second assembly direction into an end position via pivoting the at least one locking lever, the first module interface coupled to the first carrier interface and the second module interface coupled to the second carrier interface when the at least one battery cell module is in the end position.

11. The vehicle according to claim 10, wherein the at least one battery cell module further includes at least one pin projecting parallel to the pivot axis.

12. The vehicle according to claim 11, wherein the at least one locking lever includes at least one pin receptacle, the at least one pin disposed in the at least one pin receptacle in the first assembly direction when the at least one locking lever is the open position.

13. The vehicle according to claim 12, wherein the at least one locking lever further includes a slotted link which follows the at least one pin receptacle and is configured to guide the at least one pin away from the at least one pin receptacle when pivoting the at least one locking lever.

14. The vehicle according to claim 13, wherein the slotted link defines a curved track having a radius that decreases from a front end of the slotted link on the at least one pin receptacle to a rear end of the slotted link to the pivot axis.

15. The vehicle according to claim 11, wherein the at least one pin is arranged parallel to the second assembly direction and aligned with the pivot axis when the at least one locking lever is in the locking position.

16. The vehicle according to claim 10, wherein the at least one locking lever includes a grip via which the at least one locking lever is pivotable into the locking position through exertion of a mechanical force.

17. The vehicle according to claim 16, wherein the grip rests on the at least one module carrier parallel to the second assembly direction when the at least one locking lever is in the locking position.

18. The vehicle according to claim 10, wherein the battery system housing has a geometry which prevents a closing of the battery system housing when the at least one locking lever is not in the locking position.

19. A battery system for a hybrid or electric vehicle, comprising:
at least one module carrier including a fluidic first carrier interface and an electrical second carrier interface;
at least one battery cell module including:
a fluidic module cooling circuit;
a fluidic first module interface couplable to the first carrier interface for fluidically connecting the module cooling circuit to the at least one module carrier; and
an electrical second module interface couplable to the second carrier interface for electrically connecting the at least one battery cell module to the at least one module carrier;
at least one locking lever including a grip, the at least one locking lever pivotably mounted on the at least one carrier module and pivotable to an open position and a locking position via the grip, the at least one battery cell module insertable and removable from the at least one module carrier when the at least one locking lever is in the open position, and the at least one battery cell module fixed to the at least one carrier module when the at least one locking lever is in the locking position; and
a battery system housing having a geometry preventing a closing of the battery system housing when the at least one locking lever is not in the locking position;
wherein the at least one battery cell module is insertable into the at least one module carrier in a first assembly direction extending transversely to the pivot axis such that the at least one battery cell module is arrangeable, relative to the at least one module carrier, in an intermediate position where the first module interface and the second module interface are orientated in a second assembly direction extending transversely to the first assembly direction and transversely to the pivot axis, are aligned with the first carrier interface and the second carrier interface, and are arranged space apart from the first carrier interface and the second carrier interface, the at least one battery cell module engaging the at least one locking lever when the at least one battery cell is in the intermediate position and the at least one locking lever is in the open position; and
wherein the at least one battery cell module is adjustable relative to the at least one module carrier in the second assembly direction into an end position via pivoting the at least one locking lever, the first module interface coupled to the first carrier interface and the second module interface coupled to the second carrier interface when the at least one battery cell module is in the end position.

20. The battery system according to claim 19, wherein:
the at least one battery cell module further includes at least one pin projecting parallel to the pivot axis;
the at least one locking lever includes at least one pin receptacle; and
the at least one pin is disposed in the at least one pin receptacle in the first assembly direction when the at least one locking lever is the open position.
